(19) United States
(12) Patent Application Publication
(10) Pub. No.: US 2019/0098021 A1
(43) Pub. Date: Mar. 28, 2019

(54) ENHANCED SYSTEMS FOR IDENTIFYING AND MONITORING EXPECTED COMMUNICATION PATTERNS OF COMPUTING DEVICES

(71) Applicant: Microsoft Technology Licensing, LLC, Redmond, WA (US)

(72) Inventors: Jason Ryan FARMER, Snohomish, WA (US); Chirag Girish SHAH, Sammamish, WA (US)

(21) Appl. No.: 15/713,373

(22) Filed: Sep. 22, 2017

(51) Int. Cl. H04L 29/06; H04L 12/26

(52) U.S. Cl. CPC H04L 63/1408; H04L 47/24; H04L 43/04

(57) ABSTRACT

A system for enforcing expected communication patterns is provided. In some configurations, a routing device can determine one or more dedicated functions that the network-enabled device is specifically configured to perform. The routing device may also determine expected communication patterns for facilitating the one or more dedicated functions for the network-enabled device. For example, if the network-enabled device is a Smart TV, the expected communication pattern may include communications that are reasonably designed to facilitate displaying media content that is being streamed to the Smart TV. The routing device may monitor communications to and/or from the Smart TV to identify communications that are not designed to facilitate the dedicated functions. Communications that do not conform to the communication pattern can trigger the system to perform one or more security measures, which can include providing notifications, throttling selected communications, blocking selected communications, or otherwise controlling selected communications.

### BACKGROUND

Some existing network routers are designed to provide rudimentary security features that enforce whitelists and/or blacklists to prevent data communication with untrusted systems and resources. For example, a parent may configure a home routing device to prevent all data communication with a predetermined website that the parent does not permit a child to access. Such rudimentary security features are largely focused on managing web browsing activities by permitting and/or restricting access to particular web addresses. Despite providing some control over a network, such security features cannot dynamically adjust settings in reaction to different usage scenarios. In addition, existing systems require the cumbersome process of manual data entry.

Unfortunately, as people introduce new types of network-enabled devices into their networks to perform dedicated functions other than web browsing (e.g., thermostat functions, media streaming functions, etc.), some existing network routers lack the ability to determine whether these new types of network-enabled devices perform the functions expected of them. This shortcoming is exacerbated by the fact that some existing network routers further lack the ability to dynamically adjust security settings for different types of products. Such shortcomings can propagate both security issues and privacy concerns.

It is with respect to these and other considerations that the disclosure made herein is presented.

### SUMMARY

This disclosure describes systems and techniques for enabling a network routing device (also referred to hereinafter as a “routing device”) to dynamically monitor network activity of a number of network-enabled devices and to perform one or more security measures when the network activity deviates from an expected communication pattern. Generally described, configurations disclosed herein enable a routing device to determine an expected communication pattern for a particular type of network-enabled device. For example, in a scenario in which the network-enabled device is a “Smart TV,” a routing device may determine that the Smart TV displays media content that is being streamed to the Smart TV from various digital media resources that are external to a local network. Thus, an exemplary expected communication pattern for the Smart TV may be determined to include receiving continuous data streams from the various digital media resources. Once the expected communication pattern is determined, the routing device may monitor communications to and from the network-enabled device to identify a trigger event that indicates a deviation from the expected communication pattern. For example, although the Smart TV may be expected to receive continuous data streams from digital media resources, a series of intermittent data transmissions from the Smart TV to a social networking URL may indicate a deviation from the expected communication pattern. In particular, since such data transmissions are unrelated to enabling the Smart TV to display streaming media content, the Smart TV would not be expected to communicate with the social networking URL. In response to identifying a deviation from the expected communication, the routing device may perform a variety of security measures and/or predetermined actions.

In various embodiments, a routing device for managing communications within a network may obtain initialization data for a network-enabled device, such as a light, appliance, or entertainment system. The initialization data may include device credentials to enable the routing device to authenticate the network-enabled device. For example, the network-enabled device may transmit to the routing device one or more communications that are secured with a digital certificate based on a Public Key Infrastructure (PKI). Upon receipt of the one or more communications, the routing device may utilize a public key to authenticate the network-enabled device. For example, the routing device may confirm that the network-enabled device was manufactured and/or supplied by a reputable and trusted business. Based on the initialization data, the routing device may determine communication parameters that of an expected communication pattern for the network-enabled device. The expected communication pattern may identify one or more other devices within a local network that the network-enabled device is expected to or allowed to communicate with, a type of device that the network-enabled device is expected to communicate with (e.g., the Smart TV may be expected to communicate with a user's Smart phone but may not be expected to communicate with a network-enabled garage door opener), one or more external resources (i.e., resources that exist outside of a local network) that the network-enabled device is expected to communicate with, and/or one or more types and/or amounts of data that the network-enabled device is expected to send and/or receive.

Then, based on the expected communication pattern, the routing device may monitor communications data associated with the network-enabled device to identify a trigger event that corresponds to a deviation from the expected communication pattern. The trigger event may be determined, for example, based on a type of data that is being transmitted and/or received by the network-enabled device, a network address that the network-enabled device is transmitting data to and/or receiving data from, a type of device that the network-enabled device is transmitting data to and/or receiving data from, whether the network-enabled device is transmitting data to and/or receiving data from a device that is new to a local network, whether the network-enabled device contains certification credentials, and so on. In various implementations, the techniques described herein may deploy machine learning technologies to continuously analyze network activity and dynamically learn acceptable and/or unacceptable communication patterns.

In some implementations, the trigger event may be a single deviation or a pattern of deviations from an expected communication pattern. For example, the routing device may determine communication parameters that define an expected communication pattern that is specifically associated with facilitating a dedicated function. Then, any identified communication that deviates from this expected communication pattern will trigger at least one action. In some implementations, the trigger event may correspond to a deviation from the expected communication pattern that also meets one or more trigger criteria. Exemplary trigger criteria can include, but are not limited to, communication with an un-trusted external resource, communication within an unknown external resource, and/or one of several deviations that form a pattern (e.g., a network-enabled device may operate for a period of time without ever attempting to communicate with external resources and then later begins to frequently attempt to communicate with a particular external resource).

In some implementations, the routing device may monitor communications data from an inward perspective of a local network and/or from an outward perspective of the local network. Thus, while some existing network routers are merely configured to block data transmissions to and/or from one or more predetermined external resources, the techniques described herein enable the presently disclosed routing device to monitor communications between devices within the local network to determine whether such communications conform with an expected communication pattern for the monitored devices. The routing device may monitor internal communications (e.g., communications between devices within a local network) to identify, for example, particular types of network activity, particular types of data requests, types of data being transmitted, types of devices that a monitored device attempts to communicate with, and so on. As a more specific but nonlimiting example, the routing device may monitor internal communications to and/or from a network-enabled Smart Light (e.g., a PHILIPS HUE LED bulb, a GE LINK CONNECTED LED bulb, etc.) to identity one or more other devices within the local network that the network-enabled Smart Light is attempting to communicate with. Here, if the network-enabled Smart Light is polling for data from one or more devices that are unrelated to the network-enabled Smart Light's dedicated function of providing light, the routing device may identify this network activity as a trigger event and respond by implementing one or more security measures (e.g., internally blocking the attempted communications, transmitting a notification associated with the network activity, etc.). In contrast, if the network-enabled Smart Light is attempting to communicate with a related application on a smart phone within the local network, the routing device may deem this network activity as acceptable activity that conforms with the expected communication pattern of the network-enabled Smart Light.

Responsive to identifying a trigger event, the routing device may perform a variety of security measures and/or predetermined actions. For example, in some implementations the routing device may generate a notification that a network-enabled device is behaving unexpectedly. An exemplary notification may indicate, for example, an identity of the network-enabled device for which the deviation from the expected communication pattern was identified, one or more other devices within the local network that the network-enabled device is attempting to transmit data to, one or more other devices within the local network that are attempting to transmit data to the network-enabled device, a type of data associated with an attempted communication between the network-enabled device and one or more other devices within the local network and/or one or more external resources, and/or any other type of change in network activity suitable for triggering a security measure and/or predetermined action.

In some implementations, a security measures may include blocking, throttling or otherwise controlling communications that deviate from the expected communication pattern. For example, the routing device may receive and analyze an attempted communication that is intended for the network-enabled device. Then, based on a determination that the attempted communication deviates from the expected communication pattern, the routing device may refrain from transmitting the attempted communication to the network-enabled device. In some implementations, the routing device may respond to an identified trigger event by throttling network activity to the network-enabled device, limiting an amount and/or type of data that may be communicated to and/or from the network-enabled device, and/or limiting an amount and/or type of data that may be communicated to and/or from one or more other devices within a local network.

In some examples, the network-enabled device may be a network-enabled dedicated-functionality device (DFD) that is configured to transmit and/or receive data within a local network for the purpose(s) of performing one or more dedicated functions. In such implementations, the initialization data may indicate one or more dedicated functions that the network-enabled DFD is configured to perform within the local network. For example, the initialization data may indicate that the network-enabled DFD is configured to stream digital media content within the local network (e.g., for entertaining people operating devices within the local network). In some implementations, the initialization data may indicate a device-type for the network-enabled DFD wherein the device-type is associated with the one or more dedicated functions. For example, the initialization data may include an indication that the network-enabled DFD is a Smart TV. Here, the routing device may infer based on the initialization data that the network-enabled DFD is specifically configured to stream digital media content since Smart TVs are commonly associated with this dedicated functionality. The initialization data can be received from a device or the initialization data can be generated by the routing device.

In some examples where the network-enabled device is a network-enabled DFD, the expected communication pattern may be specifically associated with facilitating the one or more dedicated functions within the local network. For example, continuing with the scenario in which the network-enabled DFD is a Smart TV, the expected communication pattern may be associated with enabling the Smart TV to display media content that is being streamed to the Smart TV via the Internet. Accordingly, an expected communication pattern for the Smart TV may include transmitting intermittent data requests to one or more Trusted External Resources (TERs) that provide streaming media content (e.g., NETFLIX, HULU, AMAZON INSTANT VIDEO, PLAYSTATION VUE, HBO NOW, etc.). The expected communication pattern for the Smart TV may further include receiving continuous streams of media content data since such continuous streams enable the Smart TV to buffer and, ultimately, display media content. In some implementations, the expected communication pattern may be determined to include only communications that are directly related to facilitating the one or more dedicated functions. For example, the expected communication pattern associated with the Smart TV streaming media content may include only transmitting intermittent media requests to the trusted resource that provides streaming media content and then receiving continuous streams of the requested media content from that trusted resource. In some implementations, the expected communication pattern may be determined to include at least some communications that are tangentially related to performing the one or more dedicated functions. For example, the expected communication pattern for the Smart TV may include periodically receiving software updates from another trusted resource that manufactured the Smart TV. Such software updates may ultimately be flashed to a firmware of the network-enabled DFD(s).

Based on the expected communication pattern, the routing device may monitor communications data associated with the network-enabled DFD to identify a trigger event that corresponds to a deviation from the expected communication pattern. For example, continuing with the scenario in which the network-enabled DFD is a Smart TV, the Smart TV may be expected to transmit intermittent data requests to and receive continuous data streams from the one or more trusted resources that provide the streaming media content. However, the Smart TV would not be expected to send a series of intermittent data transmissions to a social networking service, since such data transmissions would be unrelated to the Smart TV's dedicated function of displaying streaming media content. Therefore, in response to identifying an attempted communication between the Smart TV and the social networking service, the routing device may perform one or more security measures such as blocking the attempted communication (e.g., to prevent the social networking service from harvesting data associated with viewing habits of a user of the Smart TV) and/or generate a notification that the network-enabled DFD is behaving unexpectedly.

As used herein, a local network, which is also referred to herein as a “network” or a “networked physical environment (NPE),” may refer to any physical environment that is configured with one or more network routing devices for managing a local area network (LAN) to internally connect network-enabled devices and/or for provisioning one more of the network-enabled devices with access to resources that are external to the LAN (e.g., via the internet). An exemplary NPE is a house having a routing device that enables a plurality of network-enabled DFDs to communicate with one another internally (e.g., without data being transmitted to the internet via the routing device) and further enables at least one network-enabled device to communicate with resources that are external to the NPE (e.g., resources accessible via the internet). Other exemplary NPEs include, but are not limited to, networked factories, networked school buildings, networked university campuses, networked office buildings, and/or any other physical environment suitable for deploying the techniques described herein.

As used herein, the term “network-enabled dedicated functionality device (DFD)” may refer generally to any device that is configured to transmit and/or receive data within the NPE for the purpose(s) of performing one or more dedicated functions for altering and/or monitoring aspects of the NPE. Exemplary network-enabled DFDs include, but are not limited to, Smart TVs that are configured to display streaming media content within the NPE, light bulbs configured to illuminate the NPE, thermostats configured to monitor and/or control a temperature of the NPE, a camera configured to surveil a predetermined area of the NPE (e.g., a baby monitor to surveil a crib), a robotic arm configured to perform one or more manufacturing operations within the NPE, etc. Accordingly, it can be appreciated that network-enabled DFDs may represent a sub-class of network-enabled devices that are configured to perform dedicated functions for altering and/or monitoring aspects of a physical environment. As used herein, the term “dedicated function” may refer generally to any function that may be performed by a network-enabled DFD to alter and/or monitor one or more aspects of the NPE (e.g., to monitor a temperature, surveil a crib, play audio entertainment, etc.). It can therefore be appreciated that the term “network-enabled devices” is used to describe a broad class of devices that includes both network-enabled general-purpose devices (GPDs) (e.g., laptop PCs, desktop PCs, Tablet PCs, Smart phones, etc.) as well as network-enabled DFDs.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings. The present disclosure provides improvements to existing systems, which in addition to many other technical benefits, address both security issues and privacy concerns. In addition, the present disclosure provides improvements that reduce the number of interactions required by a user, thereby reducing the number of inadvertent inputs and improving a user's experience.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items.

FIG. 1 illustrates a system that includes a routing device that facilitates a networked physical environment (NPE) to interconnect a plurality of network-enabled dedicated functionality devices (DFDs) within the NPE.

FIG. 2A is a schematic diagram of a computing environment that includes a routing device and a network-enabled DFD associated with an expected communication pattern between the plurality of network-enabled devices and/or one or more external resources.

FIG. 2B is a schematic diagram that illustrates various attempted communications that conform with and/or deviate from the expected communication pattern described in relation to FIG. 2A.

FIG. 3 illustrates a schematic diagram of a computing environment in which a routing device that facilitates an NPE places a particular network-enabled device into a quarantined subnetwork that is isolated from the NPE.

FIG. 4 illustrates aspects of a notification user interface (UI) that can be displayed on a client device to inform the administrator that the network-enabled device has attempted to join one or more networks managed by the routing device.

FIG. 5 illustrates aspects of a user interface corresponding to a communications parameters management portal that can be displayed on a device to enable a user to define communications parameters that are unique to one or more specific devices within the NPE.

FIG. 6 is a schematic diagram of an illustrative computing environment configured to deploy a machine learning engine to analyze communications parameters received from a plurality of routing devices to generate an expected communication pattern prediction model.

FIG. 7 is a flow diagram of an example method for performing security measures with respect to attempted communications that deviate from an expected communication pattern associated with a network-enabled device.

### DETAILED DESCRIPTION

Examples described herein provide various techniques that enable a routing device to dynamically monitor network activity of a network-enabled device within a networked physical environment (NPE) and to perform one or more security measures when the network activity deviates from an expected communication pattern associated with the network-enabled device. According to some examples, the routing device may receive initialization data for a network-enabled device within the NPE. The initialization data may be indicative of one or more dedicated functions that the network-enabled device is specifically configured to perform and, based thereon, an expected communication pattern may be determined for the network-enabled device that corresponds to facilitating the one or more dedicated functions. For example, in a scenario in which the network-enabled device is a Smart TV, the expected communication pattern may include communications that are reasonably designed to facilitate displaying media content that is being streamed to the Smart TV, but may omit communications that are designed to harvest data associated with a user's TV viewing habits. Accordingly, in this example, the routing device may monitor communications to and from the Smart TV to identify communications that request and/or include harvested user data associated with the user's TV viewing habits. Such communications may be identified as deviations from the expected communication pattern and, therefore, may trigger the routing device to perform one or more security measures. For example, the routing device may block deviations from the expected communication pattern from being sent from network-enabled devices to other devices within the NPE and/or external resources (whether trusted or un-trusted). As another example, the routing device may generate a notification to inform a user that a network-enabled device has attempted to transmit harvested user data and/or that another device within the NPE (or an external resource) has requested harvested user data from the network-enabled device.

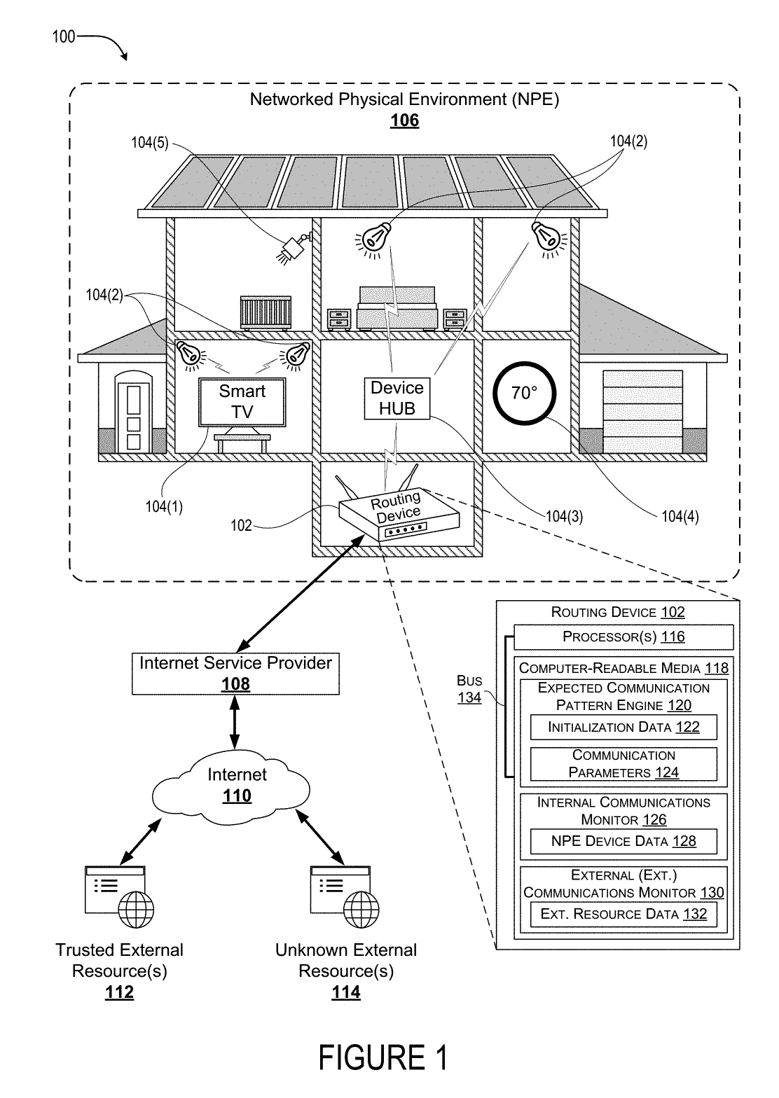

Turning now to FIG. 1, a system 100 is illustrated that includes a routing device 102 that facilitates an NPE 106 for interconnecting a plurality of network-enabled dedicated functionality devices (DFDs) 104 within the NPE 106. In particular, the routing device 102 is configured to facilitate internal communications between one or more of the network-enabled DFDs 104 within the NPE 106. In the illustrated example, the plurality of network-enabled DFDs 104 include a Smart TV 104(1) that is configured to display streaming media content into the NPE 106, one or more Smart lights 104(2) that are configured to modify the NPE 106 by generating various colors of light, a device hub 104(3) that serves as a gateway between at least some other network-enabled DFDs 104 (e.g., the Smart lights 102(2)) and the routing device 102, a Smart Thermostat 104(4) that is configured to monitor one or more environmental conditions of the NPE 106 (e.g., temperature, humidity, a presence and/or absence of occupants of the NPE 106) and/or to control one or more environmental inputs of the NPE 106 (e.g., turn on and/off a heating and/or cooling source such as a heat pump), and an audio/video (A/V) monitor 104(5) that is configured to surveil a particular area (e.g., a baby crib) within the NPE 106. It can be appreciated that the illustrated network-enabled DFDs represent merely a non-exhaustive list of exemplary network-enabled DFDs.

In some implementations, the routing device 102 may be communicatively coupled with an Internet Service Provider 108 that provides connectivity to the Internet 110 to facilitate communication between one or more of the network-enabled DFDs 104 and one or more external resources. Exemplary external resources may include, but are not limited to, trusted external resources (TERs) 112 (e.g., uniform resource locators (URL) that are external to the NPE 106 and that are known by the routing device 102 to be trusted) and/or unknown external resources 114 (URLs that are external to the NPE 106 and are unknown by the routing device 102). In various implementations, trusted external resources may include resources that are included within a “white-list” of resources that one or more network-enabled devices within the NPE 106 are permitted to communicate with. Additionally or alternatively, trusted external resources may include resources that are omitted from a “black-list” of resources that one or more network-enabled devices within the NPE 106 are forbidden from communicating with. In various implementations, unknown external resources may include resources that are included in neither a “white-list” nor a “black-list” and/or that are not flagged as potentially malicious in a latest version of a security package that is available to the routing device 102 (e.g., anti-malware definition updates that cover the latest identified malware threats provided from the Internet Service Provider 108 and/or a manufacturer of the routing device 102).

In the illustrated example, the routing device 102 includes one or more logic device(s) and one or more computer memory devices storing instructions executable by the logic device(s) to deploy functionalities described herein with relation to FIGS. 1 through 7. For example, the routing device 102 can comprise one or more processors 116 and one or more computer-readable media 118 for storing an expected communication pattern engine 120 for determining expected communication patterns associated with individual ones of the network-enabled DFDs 104 (and/or other network-enabled GPDs within the NPE 106), an internal communications monitor 126 for monitoring attempted communications between two or more of the network-enabled DFDs 104, and/or an external communications monitor 130 for monitoring attempted communications between one or more of the network-enabled DFDs 104 and one or more external resources (e.g., trusted external resources 112, unknown external resources 114, and/or any other type of external resource accessible via the Internet 110). The components of the routing device 102 are operatively connected, for example, via a bus 134, which can include one or more of a system bus, a data bus, an address bus, a PCI bus, a Mini-PCI bus, and any variety of local, peripheral, and/or independent buses.

As used herein, the term “attempted communication” may refer generally to any instance in which a device and/or resource transmits data that is addressed to and/or intended to be received by at least one other device and/or resource regardless of whether that data is actually received by the at least one other device and/or resource. For example, an attempted communication may be an instance in which the Smart TV 104(1) transmits data to the routing device 102 that is addressed to a Smart Light 104(2) and then the routing device 102 actually relays the data to the Smart Light 104(2). As a slightly different example, an attempted communication may be an instance in which the Smart TV 104(1) transmits data to the routing device 102 that is addressed to the Smart Light 104(2), but the routing device 102 refrains from relaying the data to the Smart Light 104(2) (e.g., due to the attempted communication deviating from an expected communication pattern between the Smart TV 104(1) and/or the Smart Light 104(2)). It can be appreciated that in both of these examples a computing-device has “attempted” to communicate with another computing-device.

The one or more processors 116 can represent, for example, a CPU-type processing unit, a field-programmable gate array (FPGA), another class of digital signal processor (DSP), or other hardware logic components that may, in some instances, be driven by a central processing unit (CPU). For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

The computer-readable media 118 can include computer storage media and/or communication media. Computer storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, rotating media, optical cards or other optical storage media, magnetic storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. As used herein, “computer-readable media,” such as the computer-readable media 118, can store instructions executable by a processor(s) such as, for example, the processor(s) 116 and/or external processing units such as an external CPU, an external GPU, and/or executable by an external accelerator (e.g., an FPGA type accelerator, a DSP type accelerator, or any other type of accelerator).

In contrast to computer storage media, communication media can embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

In some embodiments, the expected communication pattern engine 120 may obtain initialization data 122 associated with individual network-enabled devices within the NPE 106 such as, for example, the plurality of network-enabled DFDs 104. The initialization data 122 may be indicative of one or more dedicated functions that the individual ones of the network-enabled DFDs 104 are designed to perform. For example, a dedicated function of the Smart TV 104(1) may be to display streaming media content that is provided by the trusted external resource 112 via the Internet 110. As another example, a dedicated function of the Smart Lights 104(2) may be to illuminate the NPE 106 in response to instructions received from one or more other network-enabled devices within the NPE 106 and/or an application that has been installed on a client-device (e.g., a laptop, a Smart phone, a tablet PC, etc.) for the purpose of controlling the Smart Lights 104(2).

In some implementations, the expected communication pattern engine 120 may determine one or more dedicated functions corresponding to an individual network-enabled DFD 104 within the NPE 106 based upon a device identifier, such as a model number or name corresponding to that individual network-enabled DFD 104. For example, suppose that the Smart TV 104(1) is a SONY model XBR-65X750D and that, upon being initialized into the NPE 106, the Smart TV 104(1) transmits the initialization data 122 to the routing device 102. Further suppose that the initialization data 122 indicates the model of the Smart TV 104(1) within a DNS “host” name field so that the Smart TV 104(1) can be represented to users as the model number XBR-65X750D (e.g., which the users may understand as being the Smart TV 104(1)) rather than a MAC address and/or IP address associated with the Smart TV 104(1). The expected communication pattern engine 120 may analyze the initialization data 122 to determine the device name for an individual network-enabled DFD 104 such as, for example, the Smart TV 104(1). Then, based on the device identifier provided in the initialization data 122, the expected communication pattern engine 120 may determine a device-type of the individual network-enabled DFD 104 wherein the device-type is associated with the one or more dedicated functions. For example, it can be readily determined that the model number XBR-65X750D corresponds to a Smart TV that is manufactured by the popular electronics manufacturer SONY, and Smart TVs are widely known to be specifically designed to stream media content (e.g., many Smart TVs even ship with various media streaming applications such as NETFLIX pre-installed).

In some implementations, the expected communication pattern engine 120 may determine the device-type by communicating with an external resource. For example, the expected communication pattern engine 120 may transmit an inquiry to the external resource wherein the inquiry indicates the device name determined for the individual network-enabled DFD 104. Then, the external resource may respond to the inquiry with an indication of the device-type (e.g., a Smart TV) and/or a source of the individual network-enabled DFD 104 (e.g., SONY in the immediate example). In some implementations, the initialization data 122 may further include device credentials to enable the routing device 102 to authenticate the network-enabled DFD 104. For example, continuing with the specific but nonlimiting scenario in which the network-enabled DFD 104 is the SONY model XBR-65X750D Smart TV, the routing device 102 may analyze the device's credentials to confirm that the Smart TV 104(1) was actually sourced from SONY. It can be appreciated that authenticating the network-enabled DFDs 104 may mitigate the risk of the routing device 102 being “spoofed” by a malicious device that is introduced into the NPE 106 and that falsely identifies itself by a device name that corresponds to a device-type that would generally be trusted.

In some embodiments, the expected communication pattern engine 120 may determine communication parameters 124 for network-enabled devices such as, for example, the illustrated network-enabled DFDs 104 and/or network-enabled GPDs within the NPE 106. The communications parameters 124 may indicate expected communication pattern patterns associated with one or more of the network-enabled devices. The expected communication patterns may be defined inclusively in terms of one or more communication patterns that are expected to be associated with one or more network-enabled devices. For example, an expected communication pattern for the Smart TV 104(1) may be defined in terms of one or more trusted external resources 112 that the Smart TV 104(1) is expected to communicate with while performing its dedicated function of displaying streaming media content. As a more specific but nonlimiting example, the Smart TV 104(1) may be expected to communicate with NETFLIX and/or HULU because both of these exemplary entities are known to be “Media Streaming Services” that enable Smart TVs to display streaming media content. Additionally or alternatively, the expected communication pattern(s) may be defined exclusively in terms of one or more communication patterns that are explicitly not expected to be associated with one or more network-enabled devices. For example, the expected communication pattern for the Smart TV 104(1) may further be defined in terms of one or more other external resources (whether trusted or un-trusted) that the Smart TV 104(1) is not expected to communicate with while performing its dedicated function of displaying streaming media content. As a more specific but nonlimiting example, a reasonable expectation may be that the Smart TV 104(1) does not communicate with a social networking website (even though the social networking website is not “blacklisted” at the routing device 102) due to the social networking website being substantially unassociated with facilitating Smart TVs to display streaming media content.

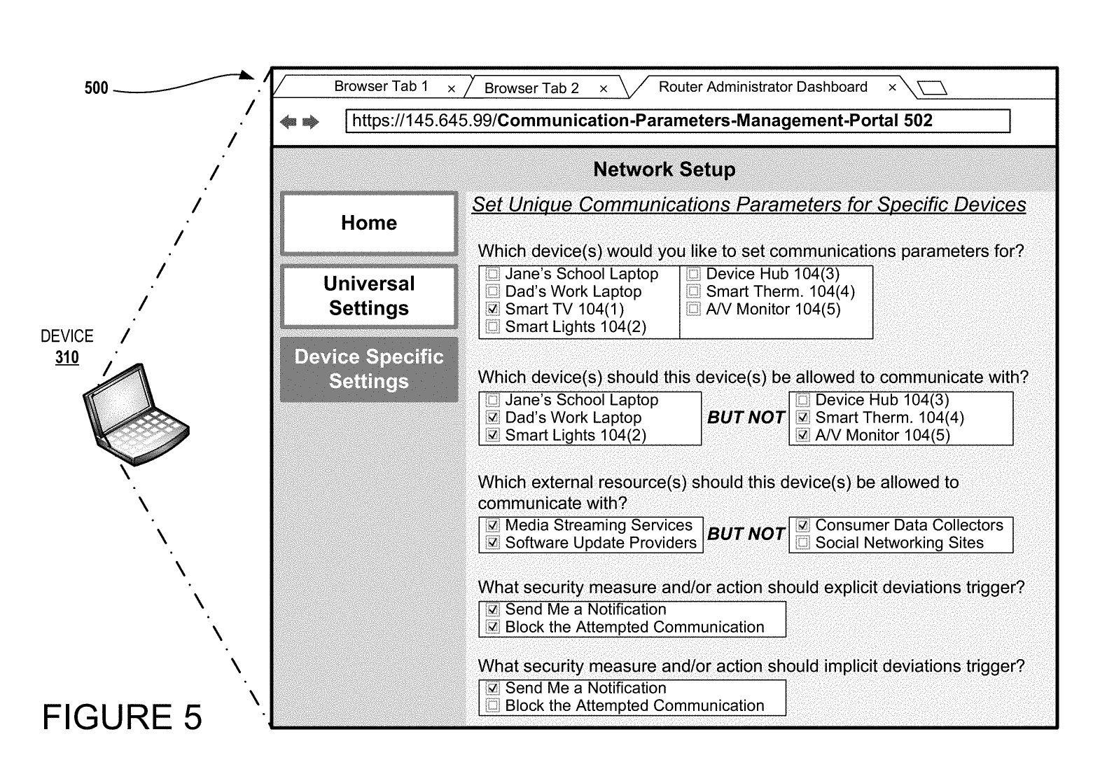

In some embodiments, the communication parameters 124 may define explicit permissions and/or restrictions in association with individual network-enabled DFDs 104 and/or classifications of network-enabled DFDs (e.g., defined by a “device-type” such as a “Smart TV,” a “Bluetooth-Enabled Speaker,” a “Video-Enabled Doorbell,” etc.). For example, the communication parameters 124 may indicate that the Smart TV 104(1) is expressly permitted to communicate with the Smart Light 104(2) and/or the device hub 104(3), but that the Smart TV 104(1) is expressly forbidden from communicating with any unknown external resources 114 and is also forbidden from communicating with the A/V monitor 104(5). As described in more detail with relation to FIG. 5, in some implementations one or more graphical user interfaces (GUIs) may be exposed to enable a user to define various aspects of the communication parameters 124. For example, an exemplary GUI may enable a user to expressly define permissions and/or restrictions corresponding to individual network-enabled devices and also to indicate aspects of the expected communication pattern(s) for individual network-enabled DFDs 104.

In some implementations, the routing device 102 includes the internal communications monitor 126 to monitor internal communications between two or more of the network-enabled DFDs 104. The internal communications monitor 126 may analyze internal communications associated with a particular network-enabled DFD 104 based upon the communication parameters 124 for that particular network-enabled DFD 104 and/or NPE device data 128 associated with one or more other network-enabled DFDs and/or GPDs that reside within the NPE 106. The NPE device data 128 may include various types of information associated with the one or more other network-enabled DFDs and/or GPDs to enable the internal communications monitor 126 to analyze communications associated with the particular network-enabled DFD 104 to determine whether any particular attempted communication conforms with or deviates from an expected communication pattern that corresponds to the particular network-enabled DFD 104. As a more specific but nonlimiting example, the NPE device data 128 may include a unique identifier (e.g., a media access control (MAC) (address) associated with each individual one of the Smart lights 104(2), the device hub 104(3), the Smart thermostat 104(4), and the A/V monitor 104(5). The NPE device data 128 may further include indications of a device-type in association with one or more of the unique identifiers to enable the internal communications monitor 126 to determine the type of device that is attempting to communicate with the particular network-enabled DFD (or the type of device that the particular network-enabled DFD is attempting to communicate with). Therefore, in some implementations, the internal communications monitor 126 is enabled to determine whether a particular attempted internal communication deviates from the expected communication pattern (or otherwise conforms with the communications parameters 124) based upon the unique identifier of another network-enabled device corresponding to the particular attempted internal communication and/or a device-type of the other network-enabled device.

In some implementations, the internal communications monitor 126 is configured to monitor attempted internal communications between a network-enabled DFD 104 and a network-enabled GPD within the NPE 106. For example, the NPE device data 128 may identify a particular network-enabled GPD as an “administrator” device that is given unrestricted permission to communicate with the various network-enabled devices within the NPE 106. For example, in a scenario in which the NPE 106 is a home, the “administrator” device may be a parent's laptop computer. Under these circumstances, the internal communications monitor 126 may analyze attempted internal communications associated with a particular network-enabled DFD 104 in order to permit communications with the particular network-enabled GPD that is flagged as the “administrator” device while denying communications with one or more other network-enabled GPDs. For example, in an instance in which a Wi-Fi password is provided to a guest and/or child to enable them to access the Internet 110 with their personal smart phone, the routing device 102 may facilitate access to the Internet 110 while simultaneously preventing this personal smart phone from communicating with other network-enabled devices within the NPE 106.

In some implementations, the routing device 102 includes the external communications monitor 130 to monitor attempted external communications between one or more of the network-enabled DFDs 104 and one or more external resources such as, for example, the trusted external resources 112 and/or the unknown external resources 114. The external communications monitor 130 may analyze attempted external communications associated with a particular network-enabled DFD 104 with respect to the communication parameters 124 for that particular network-enabled DFD 104 and/or external resource data 132 associated with one or more external resources that reside outside the NPE 106 (e.g., resources that are available through the Internet 110). The external resource data 132 may include various types of information associated with the one or more external resources to enable the external communications monitor 130 to analyze attempted communications between a particular network-enabled DFD 104 and one or more external resources. The external communications monitor 130 may then determine whether any particular attempted communication conforms with or deviates from an expected communication pattern that corresponds to the particular network-enabled DFD 104.

In some implementations, the external communications monitor 130 may determine whether a particular attempted communication conforms with or deviates from the expected communication pattern based upon a classification associated with the external resource. For example, a particular external resource may be classified as a “Media Streaming Service” along with a plurality of other external resources that are known to provide streaming media content (e.g., NETFLIX, HULU, AMAZON INSTANT VIDEO, etc.). Then, the Smart TV 104(1) may attempt to transmit a data request to the particular external resource. Under these circumstances, the external communications monitor 130 may analyze the data request to determine whether this attempted communication conforms with the expected communication pattern for the Smart TV 104(1) based upon the device-type for the Smart TV 104(1) (e.g., as indicated in the initialization data 122 and/or the communication parameters 124) and the external resource data 132 indicating that the particular external resource that the Smart TV 104(1) is attempting to communicate with is classified as a “Media Streaming Service.” In contrast, if the Smart TV 104(1) is attempting to transmit data to an external resource that is classified within the external resource data 132 as an “Online Retailer” and/or a “Consumer Data Collection Service,” the external communications monitor 130 may flag such attempted communications as deviations from the expected communication pattern and/or trigger events that cause one or more security measures to be performed (e.g., blocking the attempted communication and/or notifying a user of the attempted communication).

The routing device 102 may identify one or more trigger events based on whether the individual attempted communications deviate from the expected communication pattern (or otherwise conform with communications parameters 124) and in response thereto may cause various security measures and/or other predetermined actions to be taken. For example, in some implementations, the routing device 102 may generate a notification that a particular network-enabled device is behaving unexpectedly. An exemplary notification may indicate, for example, an identity of the network-enabled device for which the deviation(s) from the expected communication pattern was identified, one or more other devices within the NPE 106 that the network-enabled device is attempting to transmit data to (or that are attempting to transmit data to the network-enabled device), one or more external resources that the network-enabled devices are attempting to transmit data to (or that are attempting to transmit data to the network-enabled device), a type of data associated with an attempted communication that deviates from the expected communication pattern, a classification for an external resource that the network-enabled device is attempting to transmit data to (or that are attempting to transmit data to the network-enabled device), and/or any other type of network activity suitable for triggering a security measure and/or predetermined action. As described herein, a security measure can also include throttling the communication of one or more devices, blocking the communication of one or more devices, or otherwise controlling the communication of one or more devices.

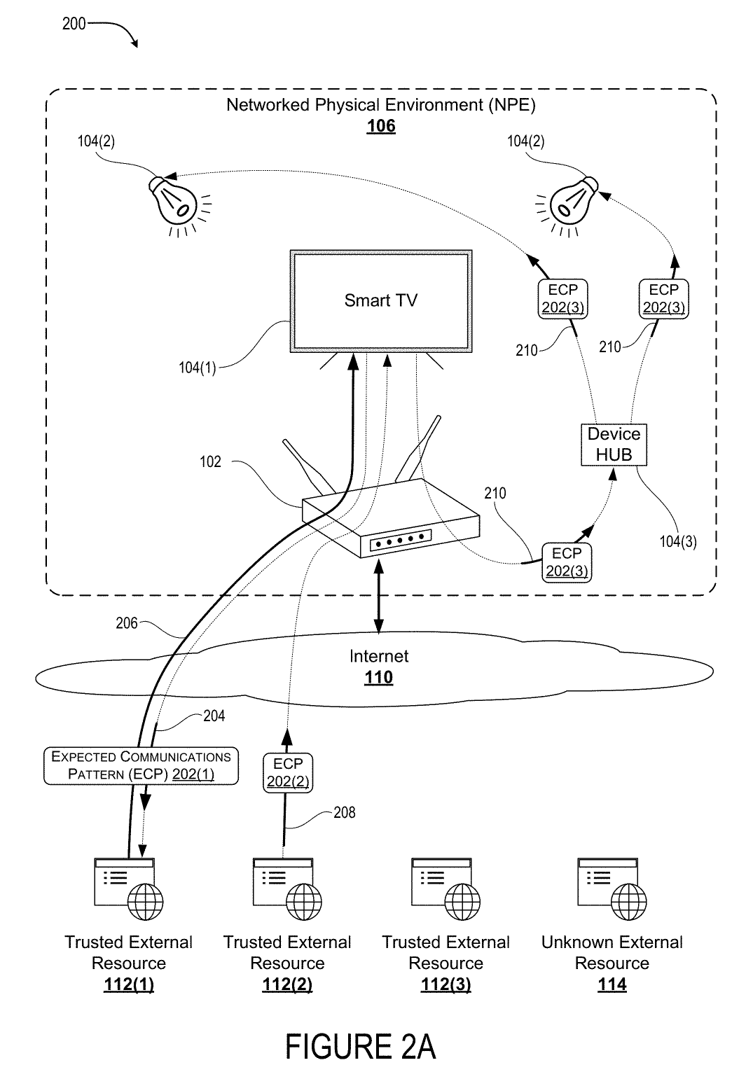

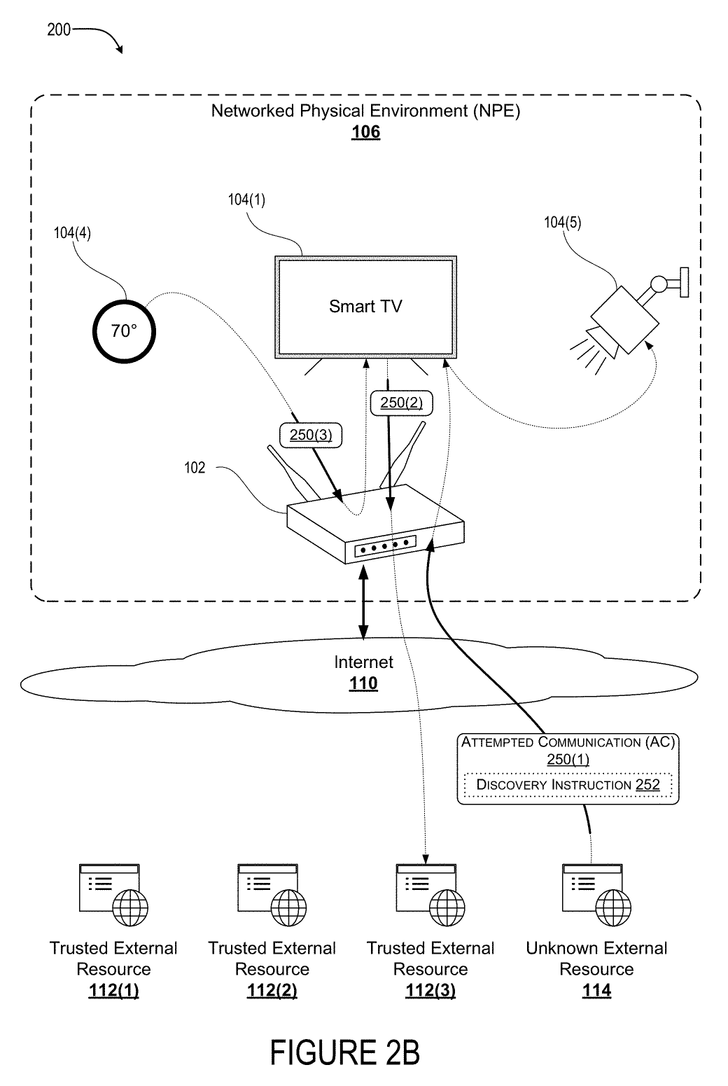

FIGS. 2A and 2B (collectively referred to herein as FIG. 2) are schematic diagrams that illustrate aspects of an expected communication pattern for a network-enabled DFD 104 and attempted communications that deviate from the expected communication pattern. In particular, FIG. 2A is a schematic diagram of a computing environment 200 that includes a routing device 102 and a network-enabled DFD 104 associated with an expected communication pattern between a plurality of network-enabled devices and/or one or more external resources. FIG. 2B is a schematic diagram that illustrates various attempted communications that conform with and/or deviate from the expected communication pattern described in relation to FIG. 2A.

Referring specifically to FIG. 2A, the routing device 102 included in the computing environment 200 facilitates an NPE 106 to interconnect a plurality of network-enabled devices and/or to enable individual ones of the plurality of network-enabled devices to communicate with various external resources via the Internet 110. In the illustrated example, the network-enabled devices include a Smart TV 104(1), two Smart Lights 104(2), and a device hub 104(3) that is configured to relay communications between the two Smart Lights 104(2) and various other network-enabled devices and/or external resources. Also illustrated in FIG. 2A is an expected communication pattern 202 that corresponds to the Smart TV 104(1). In some embodiments, expected communication patterns may uniquely correspond to individual network-enabled devices. For example, the illustrated expected communication pattern 202 may uniquely correspond to the Smart TV 104(1), but no other network-enabled device within the computing environment 200. In some embodiments, expected communication patterns may correspond to multiple network-enabled devices. For example, aspects of the illustrated expected communication pattern 202 may be designated as a “Media Streaming” communication pattern that may be associated with multiple network-enabled devices that are determined to be associated with media streaming functionality. As a more specific but nonlimiting example, the expected communication pattern 202 illustrated in FIG. 2A may be associated with the Smart TV 104(1) and may further be associated with one or more other devices (not shown) within the computing architecture 200 such as, for example, one or more network-enabled DFDs and/or one or more network-enabled GPDs.

In some embodiments, an expected communication pattern may be defined in terms of a plurality of components' expected communication patterns. For example, as illustrated in FIG. 2A, the expected communication pattern 202 is an aggregation of a first expected communication pattern 202(1) between the Smart TV 104(1) and a first trusted external resource 112(1), a second expected communication pattern 202(2) between the Smart TV 104(1) and a second trusted external resource 112(2), and a third expected communication pattern 202(3) between the Smart TV 104(1) and one or more other network-enabled DFDs 104 within the NPE 106.

In some embodiments, aspects of an expected communication pattern may be defined in terms of an amount of data sent between a particular network-enabled device within the NPE 106 and one or more other network-enabled devices within the NPE 106 and/or one or more external resources. For example, as illustrated in FIG. 2A, the first expected communication pattern 202(1) includes intermittent data requests 204 that may be sent from the Smart TV 104(1) to the first trusted external resource 112(1). As further illustrated, the first expected communication pattern 202(1) also includes continuous data streams 206 that may be transmitted from the first trusted external resource 112(1) to the Smart TV 104(1). For illustrative purposes, consider that a dedicated function of the Smart TV 104(1) is displaying streaming media content. Accordingly, it may be expected that the Smart TV 104(1) will transmit intermittent communications to the first trusted external resource 112(1) (which may be classified as a “Media Streaming Service” as described above) to request information such as which Media Titles are available from the first trusted external resource 112(1) and, ultimately, to initiate the continuous data streams 206 by selecting an individual one of the available Media Titles. Similarly, it may be expected that the Smart TV 104(1) receives the continuous data streams 206 because such communications directly facilitate displaying the streaming media content.

In some implementations, the amount(s) of data defined by the expected communication pattern may be directionally dependent. For example, although the Smart TV 104(1) may need to receive large streams of media content from the first trusted external resource 112(1) in order to perform its dedicated function, it may be completely unnecessary for the Smart TV 104(1) to provide large amounts of data to the first trusted external resource 112(1) (or any other external resource and/or network-enabled device). Thus, an expected communication pattern between any particular network-enabled device within the NPE 106 and an external resource (and/or another network-enabled device within the NPE 106) may be defined in terms of a first data transmission pattern that is expected to be transmitted to the particular network-enabled device and a second data transmission pattern that is expected to be transmitted by the particular network-enabled device.

In some embodiments, aspects of an expected communication pattern may be defined in terms of a source of data sent between the network-enabled device within the NPE 106 and one or more other network-enabled devices within the NPE 106 and/or one or more external resources. For example, as illustrated in FIG. 2A, the second expected communication pattern 202(2) includes an attempted communication 208 between the Smart TV 104(1) and a second trusted external resource 112(2). For illustrative purposes, suppose that the second trusted external resource 112(2) is specifically associated with the Smart TV 104(1) in some way-- (e.g., the second trusted external resource 112(2) may be known to provide periodic software updates for the Smart TV 104(1)). Under these circumstances, the expected communication pattern 202 may include an indication that the Smart TV 104(1) is expected to receive periodic software updates and furthermore that the expected “source” of these periodic software updates is the second trusted external resource 112(2).

In some embodiments, aspects of an expected communication pattern may be defined in terms of a type of data sent between the network-enabled device within the NPE 106 and one or more other network-enabled devices within the NPE 106 and/or one or more external resources. For example, as illustrated in FIG. 2A, the third expected communication pattern 202(3) corresponds to attempted communications 210 between the Smart TV 104(1) and the device hub 104(3) wherein the purpose of these attempted communications 210 are limited to managing the Smart lights 104(2). Accordingly, attempted communications sent from the Smart TV 104(1) that are designated for the device hub 104(3) and/or the Smart lights 104(2) may be determined to conform with the third expected communication pattern 202(3) when they include data types that are designed to manage the Smart lights 104(2). In contrast, other attempted communications sent from the Smart TV 104(1) that are designated for the device hub 104(3) and/or the Smart lights 104(2) may be determined to deviate from the third expected communication pattern 202(3) when they include data types that are unrelated to managing the Smart lights 104(2). In some implementations, the routing device 102 may be configured with a packet analyzer computer program to perform packet analysis with respect to individual attempted communications 210 to identify one or more types of data contained within the attempted communications. Ultimately, the routing device 102 may determine whether individual attempted communications conform with or deviate from one or more expected communication patterns and/or communications parameters 124 based on the one or more types of data identified by performing packet analysis against the attempted communications.

Referring now specifically to FIG. 2B, a schematic diagram of the computing environment 200 illustrates a plurality of attempted communications 250 that deviate from the expected communication pattern 202 described in relation to FIG. 2A.

In some implementations, the routing device 102 may be configured to analyze attempted communications 250 that deviate from the expected communication pattern 202 to determine whether a particular deviation should trigger one or more security measures and/or predetermined actions. For example, consider the illustrated scenario in which an unknown external resource 114 has transmitted to the routing device 102, via the Internet 110, a first attempted communication 250(1) that is addressed to the Smart TV 104(1). In this scenario, the first attempted communication 250(1) includes a discovery instruction 252 that is designed to cause a recipient network-enabled device to perform a discovery protocol to facilitate direct communication (e.g., Wi-Fi Direct communication) between the recipient network-enabled device and one or more other network-enabled devices within a corresponding local area network (LAN). For example, the discovery instruction 252 may be designed to cause the Smart TV 104(1) to discover and then directly communicate with one or more other network-enabled DFDs such as, for example, the A/V monitor 104(5). Under these circumstances, the routing device 102 may perform packet analysis of the first attempted communication 250(1), and based thereon may identify the discovery instruction 252 (and/or some other type of potentially malicious code). As illustrated, in response to the first attempted communication 250(1) deviating from the expected communication pattern 202 and meeting one or more trigger criterion (e.g., including potentially malicious code), the routing device 102 performs the security measure of refraining from relaying the first attempted communication 250(1) to the Smart TV 104(1).

In some implementations, the routing device 102 may be configured to prevent attempted communications that deviate from the expected communication pattern 202 even when such attempted communications are sent from and/or addressed to a trusted external resource that one or more other devices (e.g., laptop computer, a smart phone, etc.) within the NPE 106 are fully permitted to communicate with. For example, consider the illustrated scenario in which the Smart TV 104(1) has transmitted to the routing device 102 a second attempted communication 250(2) that is addressed to a third trusted external resource 112(3). Further suppose that the third trusted external resource 112(3) is a social networking resource that is frequently visited by one or more users within the NPE 106 using various network-enabled devices other than the Smart TV 104(1), but that the one or more users are not expected to access using the Smart TV 104(1). Thus, as illustrated, even though the second attempted communication 250(2) is addressed to a trusted external resource (which may even be explicitly “white-listed” at the routing device 102 to enable one or more other devices within the NPE 106 to freely communicate with the trusted external resource), the routing device 102 may nonetheless perform the security measure of refraining from relaying the second attempted communication 250(2) to the third trusted external resource 112(3). Stated alternatively, unlike some existing network routers which indiscriminately “whitelist” and/or “blacklist” URLs from an entire LAN, the techniques disclosed herein enable the routing device 102 to selectively block communications from external resources on an individual device basis within the NPE 106. It can be appreciated that such an implementation may be of increasing interest as many trusted and marketable businesses are continually inventing new ways of acquiring valuable consumer data such as, for example, a user's TV watching habits and/or any other data type that may trigger privacy concerns from the typical user.

In some implementations, the routing device 102 may be configured to identify internal attempted communications (i.e., attempted communications between two or more network-enabled devices that reside within the NPE 106) that deviate from the expected communication pattern 202 to determine whether a particular internal deviation should trigger one or more security measures and/or predetermined actions. For example, consider the illustrated scenario in which the Smart Thermostat 104(4) has transmitted to the routing device 102 the third attempted communication 250(3) which may be addressed to the Smart TV 104(1). It can be appreciated from the expected communication pattern described in relation to FIG. 2A that the Smart Thermostat 104(4) is not expected to send any communications to the Smart TV 104(1), and vice versa. Accordingly, the routing device 102 may perform the security measure of blocking any attempted communications between the Smart Thermostat 104(4) and the Smart TV 104(1) (or any other network-enabled devices within the NPE 106). It can be appreciated that such an implementation may be of increasing interest as the proliferation of network-enabled DFDs (e.g., Smart appliances, Smart electronics, Internet-of-Things (IoT) devices) continually increases the potential channels with which security breaches become possible.

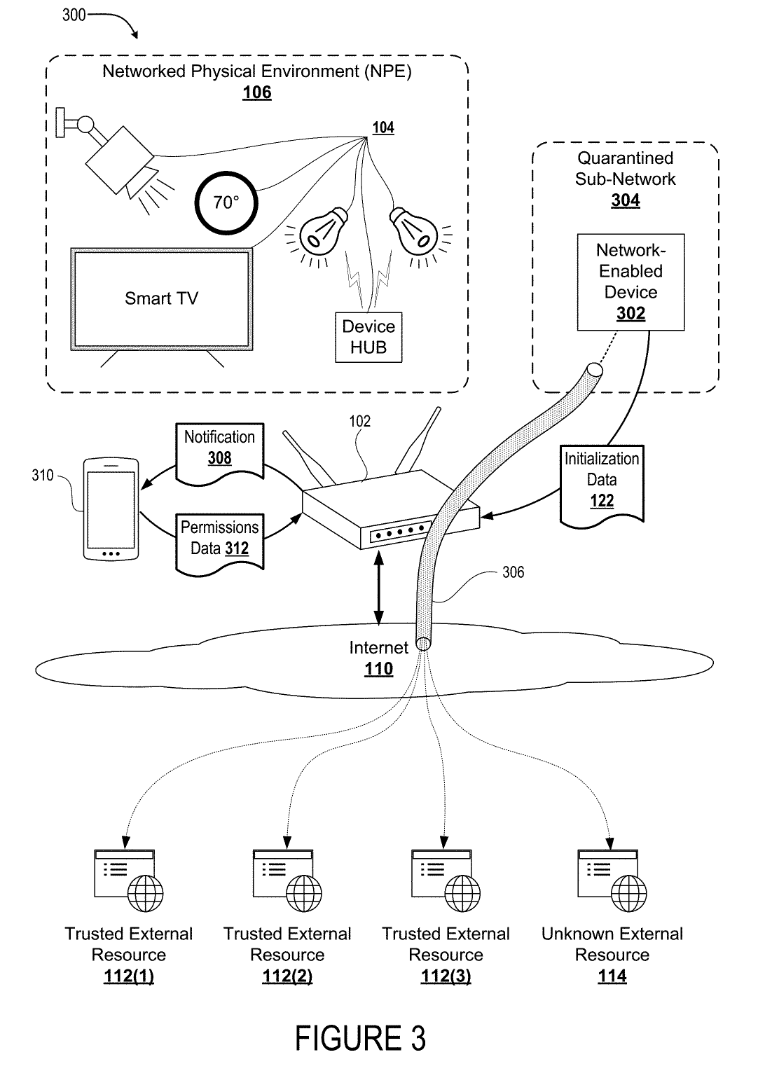

Turning now to FIG. 3, a schematic diagram is illustrated of a computing environment 300 in which a routing device 102 that facilitates an NPE 106 places a particular network-enabled device 302 into quarantined sub-network 304 that is isolated from the NPE 106. In particular, the routing device 102 is shown to generate a communication channel 306 to provide the particular network-enabled device 302 with an ability to communicate with one or more external resources via the Internet 110, but which does not provide the network-enabled device 302 with visibility to a plurality of network-enabled devices that reside within the NPE 106. In the illustrated scenario, the plurality of network-enabled devices includes the plurality of network-enabled DFDs 104 as shown in FIG. 1. It should be appreciated, however, that the plurality of network-enabled devices encompass a variety of different types of network-enabled devices including one or more network-enabled DFDs, one or more network-enabled GPDs (e.g., laptop PCs, desktop PCs, Tablet PCs, Smart phones, etc.), or a combination thereof.

In some implementations, the network-enabled device 302 may be placed into the quarantined subnetwork 304 in response to providing initialization data 122 to the routing device 102. For example, the network-enabled device 302 may be a client computing device that comes within range of a wireless signal generated by the routing device 102 such that a corresponding WLAN becomes discoverable by the client computing device. A user may then select and attempt to join the WLAN which prompts the initialization data 122 to be sent to the routing device 102. In some implementations, the routing device 102 is configured to analyze the initialization data 122 and determine based thereon whether to provide the network-enabled device 302 with access to the NPE 106 (e.g., to let the network-enabled device join the NPE 106) so that the network-enabled DFDs 104 within the NPE 106 become discoverable by the network-enabled device 302, or whether to provide the network-enabled device 302 with limited access to various resources by placing the network-enabled device within the quarantined subnetwork 304.

In some implementations, the routing device 102 may transmit a notification 308 to a predetermined client device 310 that is associated with the NPE 106 and/or the routing device 102. For example, the predetermined client device 310 may be a smart phone that is owned by an administrator that initialized the NPE 106 via an administrator dashboard generated by the routing device 102. The notification 308 may inform the administrator that the network-enabled device 302 has provided the initialization data 122 and attempted to join one or more networks managed by the routing device 102. For example, in a scenario in which the NPE 106 is a home-based WLAN as depicted in FIG. 1, the WLAN may be discoverable by the network-enabled device 302 when in range of the routing device via an available networks user interface generated by the network-enabled device 302. Then, the user may select the WLAN from a list of one or more available WLANs and, if applicable, provide a password to the routing device within the initialization data 122. The notification 308 may be responsive to the network-enabled device attempting to join a network managed by the routing device 102.

In some implementations, the notification 308 may enable the administrator to define permissions data 312 that defines access permissions for the network-enabled device 302 with respect to one or more networks managed by the routing device 102. As a more specific but nonlimiting example, upon attempting to join the one or more networks managed by the routing device 102, the routing device 102 may automatically place the network-enabled device 302 within the quarantined subnetwork 304 that exclusively permits Internet access but does not enable communication between the network-enabled device 302 and any device within the NPE 106. Then, upon receiving the notification 308, the administrator may respond with the permissions data 312 to instruct the routing device 102 to upgrade the network-enabled device's 302 permissions by allowing it to join the NPE 106, leaving the network-enabled device's 302 permissions as the default permissions (e.g., whichever permissions were automatically applied by the routing device 102 prior to receiving the permissions data 312, if any is sent), or to downgrade the network-enabled device's 302 permissions by restricting access to even the quarantined subnetwork 304. In some implementations, the routing device 102 may be configured to automatically allow the network-enabled device 302 to join the NPE 106 (e.g., before either of the notification 308 and or the permissions data 312 is sent and/or generated). Then, the notification 308 may enable the administrator to modify its permissions for the network-enabled device 302 if desired. Such a scenario may be desirable when a majority of devices are permitted with unfettered access to join the NPE 106. In some implementations, the routing device 102 may be configured to automatically place the network-enabled device 302 within the quarantined subnetwork 304, at least until such time as permissions data 312 expressly indicates that the network-enabled device 302 is permitted to join the NPE 106, and/or expressly indicates that the network-enabled device 302 should not be allowed access to even the quarantined subnetwork 304. Such a scenario may be desirable when the majority of devices are to be provided with unfettered access to the Internet but should not be permitted to communicate with any devices within the NPE 106. In some implementations, the routing device 102 may be configured to automatically restrict the network-enabled device 302 from accessing the NPE 106 and the quarantined subnetwork 304 until such time as permissions data 312 indicates otherwise.

In some implementations, the routing device 102 may be configured to dynamically control permissions data 312 for the network-enabled device 302 based upon a password provided by the network-enabled device 302 in the initialization data 122. For example, the routing device 102 may associate a first password with the NPE 106 and a second password with one or more quarantined subnetworks 304. Then, depending on whether the initialization data 122 includes the first password or the second password, the routing device 102 may dynamically determine whether to permit the network-enabled device 302 to fully join the NPE 106 or, alternatively, to place the network-enabled device 302 within the quarantined subnetwork 304. As a more specific but nonlimiting example, the administrator may define a relatively easy to remember but unsecure first password such as, for example, “123GOHUSKIES” that can be provided by network-enabled devices to gain access to the quarantined subnetwork 304 to gain Internet access alone. The administrator may then define a relatively hard to remember but more secure second password such as, for example, “K;dz)h74N′8ACz” that can be provided by network-enabled devices to gain access to the NPE 106. Under this specific example, the administrator may add his or her personal devices to the NPE 106 using the second password and may easily remember the first password to provide to guests that request Internet access visiting the physical environment associated with the NPE 106 (e.g., a house, factory, coffee shop, etc.).

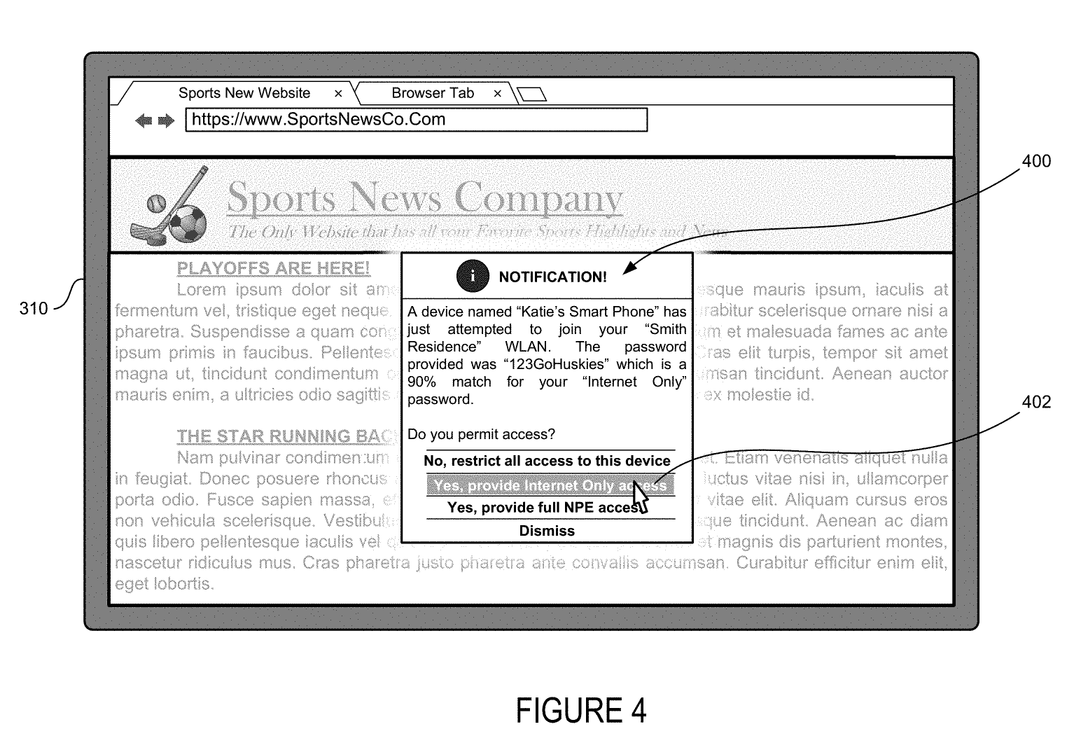

FIG. 4 illustrates aspects of a notification UI 400 that can be displayed on a client device 310 to inform the administrator that the network-enabled device 302 has attempted to join one or more networks managed by the routing device 102. As illustrated, the notification UI 400 is informing the user that a device (e.g., a device named “Katie's Smart Phone”) is just attempted to join a particular network (e.g., a WLAN named “Smith Residence”). In various implementations, the notification UI 400 may be in the form of a pop-up type notification that is generated in a foreground of (e.g., superimposed over) one or more other applications being operated by the user. In the illustrated example, the user is operating in a web browsing application that is not specifically associated with managing the routing device 102 and/or defining configuration parameters 124. In some embodiments, the notification UI 400 may indicate a password provided in the initialization data 122 sent from the network-enabled device 302. As illustrated, the notification UI 400 further indicates that the password provided by “Katie's Smart Phone” was a 90% match to the second password that is designed to cause the routing device 102 to provide Internet access only (e.g., by placing an associated device within the quarantined subnetwork 304 to provide Internet access via the communication channel 306).

In various implementations, the notification UI 400 may also include one or more user interface elements (UIEs) 402 that enable the administrator to generate selection data to select between one or more actions that the routing device 102 may take with respect to the network-enabled device 302. For example, as illustrated, the UIEs enable the administrator to select between restricting all access to the device so that the device can neither access the Internet nor see other devices within the NPE 106 (e.g., placing the device in neither the NPE 106 nor the quarantined subnetwork 304), providing Internet access only (e.g., by placing the device in the quarantined subnetwork 304), or providing the device with access to the networks managed by the routing device 102 (e.g., by placing the device in the NPE 106 so that other devices are discoverable). As further illustrated, the UIEs 402 may enable the administrator to dismiss the notification. It can be appreciated that the implementation described with respect to FIG. 4 may be beneficial under circumstances in which the administrator verbally provides the password to a guest of his or her home but is not physically present when the guest initially tends to access the Internet. For example, the password provided in the initialization data 122 was correct except for capitalization errors which may not have been understood by the guest if the password was received verbally. Accordingly, because the administrator was expecting the guest to join the network and the device name and/or password provided in the initialization data suggests that the device attempting to join the network is owned by the guest, the administrator may elect to simply grant access immediately without confirming with the guest that she or he did in fact try to attempt the network.

Turning now to FIG. 5, aspects are illustrated of a user interface (UI) 500 corresponding to a communications parameters management portal (CPMP) 502 that can be displayed on a device to enable a user (administrator) to define communications parameters 124 that are unique to one or more specific devices within the NPE 106. In the illustrated scenario, a user is defining communications parameters 124 that are unique to a network-enabled DFD and, more specifically, the Smart TV 104(1). It can be appreciated from the illustrated scenario that the CPMP 502 may, in some embodiments, enable the user to define communications parameters 124 that are unique to specific network-enabled GPDs within the NPE 106. An expected communication pattern may be determined for the Smart TV 104(1) based at least in part on communications parameters 124 that are provided by a user via the CPMP 502.

In some implementations, a user may use a computing device such as a laptop computer to generate a request to define one or more communications parameters 124 via the CPMP 502. For example, using a web browsing application on the computing device, the user may enter a specific address associated with the routing device 102 into an address bar of the web browsing application. For example, in the illustrated scenario the user has entered “145.645.99” into the address bar which has in turn exposed a communication parameters management portal 502.

In some implementations, the CPMP 502 may enable the user to specifically define one or more other devices within the NPE 106 that a particular network-enabled device is permitted to communicate with. In the illustrated scenario, a user is defining communications parameters 124 that permit the Smart TV 104(1) to communicate with a particular network-enabled GPD (e.g., “Dad's Work Laptop”) as well as a particular network-enabled DFD (e.g., the Smart Lights 104(2)). In some implementations, the CPMP 502 may enable the user to specifically define one or more other devices within the NPE 106 that a particular network-enabled device is forbidden from communicating with. In the illustrated scenario, a user is defining communications parameters 124 that forbid the Smart TV 104(1) from communicating with both the Smart thermostat 104(4) and the A/V monitor 104(5).

In some implementations, the CPMP 502 may enable the user to specifically define one or more external resources (e.g., resources that are external to the NPE 106 and accessible via the Internet 110) that a particular network-enabled device is permitted to communicate with. In the illustrated scenario, a user is defining communications parameters 124 that permit the Smart TV 104(1) to communicate with external resources that are known to be “Media Streaming Services” or “Software Update Providers.” Based on these communications parameters 124, an expected communication pattern may be determined for the Smart TV 104(1) that includes receiving large amounts of streaming content from a plurality of trusted external resources 112 (e.g., NETFLIX, HULU, etc.) and further includes periodically receiving moderately sized update packages from one or more other trusted external resources 112 (e.g., a manufacturer of the Smart TV 104(1)). In some implementations, the CPMP 502 may enable the user to specifically define one or more external resources that a particular network-enabled device is forbidden from communicating with. In the illustrated scenario, a user is defining communications parameters 124 that forbid the Smart TV 104(1) from communicating with external resources that are known to be “Consumer Data Collectors.” Based on these communications parameters 124, the expected communication pattern may explicitly define one or more entities that are known to collect personal information via public and/or private sources and sell this personal information to businesses for targeted marketing and/or advertising purposes.

In some implementations, the CPMP 502 may enable the user to specifically define one or more security measures and/or predetermined actions that should be taken when an attempted communication associated with a particular network-enabled device deviates from that device's expected communication pattern. In the illustrated scenario, a user is defining communications parameters 124 that cause deviations from the expected communication pattern of the Smart TV 104(1) to trigger a notification being sent to the user and/or the attempted communication being blocked. For example, in the event that a consumer data collector attempts to communicate with the Smart TV 104(1) (or vice versa), the routing device 102 may prevent the attempted communication from reaching the Smart TV 104(1) if it was sent by the consumer data collector, or alternatively, prevent the attempted communication from reaching the consumer data collector if it was sent from the Smart TV 104(1).

In some implementations, the CPMP 502 may enable the user to specifically define a first set of security measures and/or predetermined actions that should be taken for explicit deviations from the expected communication pattern and also a second set of security measures and/or predetermined actions that should be taken for implicit deviations from the expected communication pattern. As used herein, an “explicit deviation” refers to an attempted communication that an expected communication pattern explicitly indicates should not occur. For example, in the illustrated scenario, the communications parameters 124 provided by the user explicitly forbid the Smart TV 104(1) from communicating with consumer data collectors. Accordingly, in accordance with the illustrated scenario, an attempted communication between the Smart TV 104(1) and a known consumer data collector may be classified as an explicit deviation from the Smart TV's 104(1) expected communication pattern. As used herein, an “implicit deviation” refers to an attempted communication that an expected communication pattern neither explicitly indicates should occur (e.g., is expected to occur) nor explicitly indicates should not occur. For example, in the illustrated scenario, the communications parameters 124 provided by the user neither explicitly permit nor restrict the Smart TV 104(1) from communicating with one or more social networking sites. Accordingly, in accordance with the illustrated scenario, an attempted communication between the Smart TV 104(1) and a known social networking website may be classified as an implicit deviation from the Smart TV's 104(1) expected communication pattern.

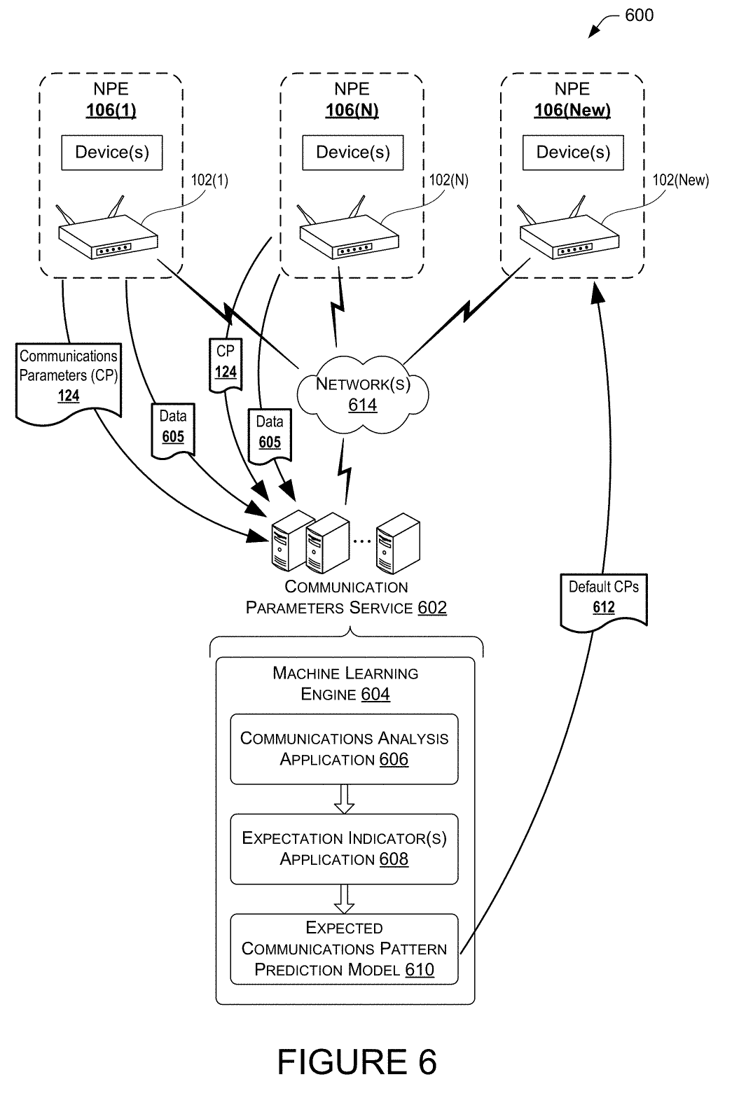

FIG. 6 is a schematic diagram of an illustrative computing environment 600 configured to deploy the machine learning engine 604 to analyze communications parameters 124 and/or other data 605 received from a plurality of routing devices 102 to generate an expected communication pattern prediction model 610. Ultimately, the expected communication pattern prediction model 610 may be utilized by a communication parameters service 602 to generate default parameters 612 for one or more routing devices 102. In the illustrated scenario, communications parameters 124 and other data 605 has been received from a first through an N-th routing device (labeled 102(1) through 102(N), respectively) for use by the communication parameters service 602 to generate default communications parameters 612 for a new routing device 102 (new).

In some embodiments, the expected communication pattern prediction model 610 may be created by employing supervised learning wherein one or more humans assists in generating labeled training data. For example, a human such as an employee of the communication parameters service 602 may label aspects of the communications parameters 124 to be used as training data for the machine learning engine 604 to extract correlations from. As a more specific but nonlimiting example, the human may label changes to the communications parameters 124 that have been defined by one or more administrators associated with the first through the N-th routing devices. Then, the machine learning engine 604 may analyze previous instances of attempted communications that are indicated within the data 605 to identify correlations between specific characteristics of the previous instances of attempted communications and changes to the communications parameters 124. Additionally or alternatively, other machine learning techniques may also be utilized, such as unsupervised learning, semi-supervised learning, classification analysis, regression analysis, clustering, etc. One or more predictive models may also be utilized, such as a group method of data handling, Naïve Bayes, k-nearest neighbor algorithm, majority classifier, support vector machines, random forests, boosted trees, Classification and Regression Trees (CART), neural networks, ordinary least square, and so on.

In the illustrated example, the machine learning engine 604 includes a communications analysis application 606 for analyzing the data 605 to identify various characteristics of previous instances of attempted communications associated with devices that are included within NPEs 106 facilitated by the first through the N-th routing devices. Exemplary characteristics of attempted communications that may be identified by the communications analysis application 606 include, but are not limited to:
Data Types: In some instances, the communications analysis application 606 may perform various data analysis techniques (e.g., packet examination) to identify specific types of data included within various attempted communications. For example, attempted communications that include various datatypes which may implicate privacy concerns (e.g., TV watching habits, Internet browsing habits, telemetry data, financial data, online retailer purchasing histories, etc.) may be identified and flagged by the communications analysis application 606.
Device Types: In some instances, the communications analysis application 606 may identify device types associated with various attempted communications. For example, attempted communications to and/or from a Smart TV may be identified and flagged to distinguish these attempted communications from other attempted communications to and/or from a network-enabled GPD within one or more of the first NPE 106(1) through the N-th NPE 106(N).
External Resource Type: In some instances, the communications analysis application 606 may identify what types of external resources are associated with various attempted communications. For example, attempted communications to and/or from consumer data collection agencies may be identified and flagged by the communications analysis application 606.
Data Provisioning Rates: In some instances, the communications analysis application 606 may classify various attempted communications according to rates at which data is being transmitted from a particular device(s) within one or more of the first NPE 106(1) through the N-th NPE 106(N). For example, attempted communications from particular DFDs to one or more external resources having data transfer rates higher or lower than a threshold rate may be identified and flagged by the communications analysis application 606.
Data Consumption Rates: In some instances, the communications analysis application 606 may classify various attempted communications according to rates at which data is being consumed by a particular device(s) within one or more of the first NPE 106(1) through the N-th NPE 106(N). For example, attempted communications that are transmitted to particular DFDs from one or more external resources having data transfer rates higher or lower than a threshold rate may be identified and flagged by the communications analysis application 606.
   Of course, other types of behavioral characteristics may also be recognized as toxic or non-toxic and are within the scope of the present disclosure.

In the illustrated example, the machine learning engine 604 includes an expectation indicator(s) application 608 to analyze the communications parameters 124 and/or data 605 to identify “indicators” that various characteristics of attempted communications (e.g., as identified by the communications analysis application 606) correspond to, conforming with and/or deviate from expected communication patterns of various devices. The expectation indicator(s) application 608 may deploy an algorithm (e.g., a decision tree, a Naive Bayes Classification, or any other type of suitable algorithm) to identify various indicators which include, but are not limited to communication parameters adjustments that correlate with specific characteristics of attempted communications. For example, in some instances, a user(s) that manages communications parameters associated with a particular routing device(s) 102 may respond to attempted communications having particular characteristics by adjusting one or more communications parameters at the routing device(s) 102. For example, a user may respond to a particular DFD attempting to communicate with a consumer data collection agency by modifying the communications parameters 124 to expressly forbid such communication. Accordingly, the expected indicator(s) application 608 may determine that these communication parameters adjustments are indicative of one or more users not expecting devices on their NPE 106 to send/receive data to/from specific types of external resources. Of course, other types of “indicators” may also be recognized as correlating with any particular characteristic of attempted communications conforming with and/or deviating from communication patterns of one or more devices that are expected by users.

Based at least partially on the “indicators” identified by the expectation indicator(s) application 608, the machine learning engine 604 may build an expected communication pattern prediction model 610 and update and/or revise the expected communication pattern prediction model 610 as data evolves over time. In some implementations, the expected communication pattern prediction model 610 may be deployed by the communication parameters service 602 to generate default communications parameters 612 to transmit to routing devices that are being newly configured. For example, in the illustrated scenario the new routing device 102(new) is in the process of being set-up by a user to initialize the new NPE 106(New). Here, rather than the user having to manually configure configuration parameters for devices within the new NPE 106(New), the user may elect to initialize the new routing device 102(new) with the default communications parameters 612.

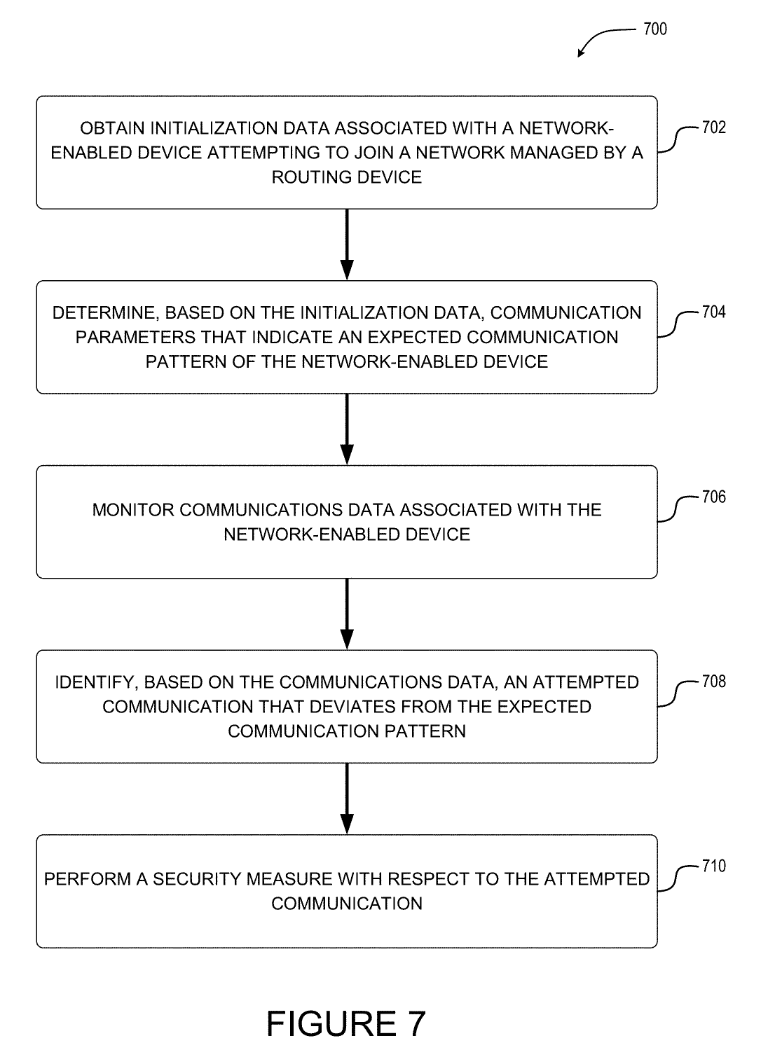

FIG. 7 illustrates an example flowchart that is described with reference to FIGS. 1 through 6. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It also should be understood that the illustrated methods can end at any time and need not be performed in their entireties. Some or all operations of the methods, and/or substantially equivalent operations, can be performed by execution of computer-executable instructions included on a computer-storage media, as defined herein. The term “computer-executable instructions,” and variants thereof, as used in the description and claims, is used expansively herein to include routines, applications, application modules, program modules, programs, components, data structures, algorithms, and the like. Computer-executable instructions can be implemented on various system configurations, including single-processor or multiprocessor systems, minicomputers, mainframe computers, personal computers, hand-held computing devices, microprocessor-based, programmable consumer electronics, combinations thereof, and the like.

FIG. 7 is a flow diagram of an example method 700 for performing security measures with respect to attempted communications that deviate from an expected communication pattern associated with a network-enabled device.

At block 702, the initialization data 122 may be obtained in association with the network-enabled device that is attempting to join a network (e.g., the NPE 106) that is managed by a routing device 102. In some implementations, the initialization data 122 may indicate a device-type of the network-enabled device. For example, the initialization data 122 may indicate that the network-enabled device is a Smart TV 104(1) or alternatively may indicate that the network-enabled device is a general-purpose computer (e.g., a laptop PC). In some implementations, the initialization data 122 may indicate one or more dedicated functions that the network-enabled device is specifically configured to perform. For example, the initialization data 122 may be indicative that the network-enabled device is specifically configured to receive, buffer, and ultimately display streaming media content.

At block 704, communications parameters 124 may be determined based on the initialization data 122. The communications parameters 124 may indicate an expected communication pattern for the network-enabled device. In some implementations in which the network-enabled device is a network-enabled DFD that is specifically configured to perform one or more dedicated functions, the expected communication pattern may be specifically associated with facilitating the one or more dedicated functions. For example, if the initialization data 122 indicates that the network-enabled device is specifically configured to receive, buffer, and display streaming media content, then the expected communication pattern may be determined to include only communications between the network-enabled device and external resources that are classified as “media streaming services.”

In some implementations, the expected communication pattern may include one or both of an expected data provisioning rate associated with the network-enabled device providing data to one or more external resources outside of the network managed by the routing device 102, or an expected data consumption rate associated with the network-enabled device receiving data from the one or more external resources. For example, continuing with the scenario where the network-enabled device is configured to display streaming media content, the expected data provisioning rate associated with the network-enabled device may be relatively low compared to a rate at which the network-enabled device is expected to consume data. Accordingly, in various implementations, an expected communication pattern for a particular network-enabled device may indicate an expected data provisioning rate for the particular network-enabled device that is different than an expected data consumption rate for the particular network-enabled device.

At block 706, communications data associated with the network-enabled device may be monitored. For example, the routing device 102 may analyze attempted internal communications between the network-enabled devices that reside within the network managed by the routing device 102 and/or attempted extra communications between the network-enabled devices and one or more external resources may be analyzed.

At block 708, an attempted communication that deviates from the expected communication pattern may be identified. For example, continuing with the scenario where the network-enabled device is configured to display streaming media content, the attempted communication may be with an external resource that is classified as a “consumer data collection agency” rather than a “media streaming service.” Based on the classification of the external resource, the attempted communication may be determined to deviate from the expected communication pattern.

At block 710, a security measure may be performed with respect to the attempted communication. In some implementations, the security measure may include causing the routing device to prevent the attempted communication from being successfully transmitted between the network-enabled device and an external resource that sent the attempted communication. In some implementations, the security measure may include generating a notification that identifies the network-enabled device and indicates aspects of how the attempted internal communication deviates from the expected communication pattern. For example, a notification may indicate that a Smart TV type of network-enabled DFD has attempted to transmit an attempted communication to a particular external resource that is not classified as a “media streaming service.” An exemplary notification may further include one or more user interface (UI) elements that enable a user to dynamically modify the communications parameters 124 associated with the network-enabled device if he or she so chooses. For example, the one or more UI elements may enable the user to redefine the expected communication pattern to include communications with the particular external resource despite the particular external resource not having been classified as a “media streaming service.” Additionally or alternatively, the one or more UI elements may enable the user to confirm that the expected communication pattern is accurate and that the attempted communication associated with the notification does in fact deviate from how the user expects the network-enabled device to communicate with other network-enabled devices within the network facilitated by the routing device 102 and/or external resources.

### EXAMPLE CLAUSES

The disclosure presented herein may be considered in view of the following clauses.

### Example 1

A routing device for managing communications within a network, the routing device comprising: one or more processors; and a memory in communication with the one or more processors, the memory having computer-readable instructions stored thereupon which, when executed by the one or more processors, cause the routing device to: obtain initialization data for a network-enabled device within the network, wherein the initialization data indicates at least one of one or more dedicated functions or a device-type associated with the one or more dedicated functions; determine, based on the one or more dedicated functions, communication parameters for the network-enabled device, wherein the communication parameters correspond to an expected communication pattern associated with facilitating the one or more dedicated functions within the network; monitor communications data associated with the network-enabled device; identify, based on the communications data, at least one trigger event that corresponds to a deviation from the expected communication pattern; and generate, in response to the at least one trigger event, a notification that identifies the network-enabled device and indicates aspects of the deviation from the expected communication pattern.

### Example 2

The routing device of Example 1, wherein the expected communication pattern includes an expected data provisioning rate associated with the network-enabled device providing data to one or more resources that are external to the network, and wherein the at least one trigger event corresponds to an actual data provisioning rate reaching a threshold level with respect to the expected data provisioning rate.

### Example 3

The routing device of Examples 1 through 2, wherein the deviation corresponds to an attempted communication between the network-enabled device and a resource other than one or more predetermined resources that at least partially enable the network-enabled device to perform the one or more dedicated functions.

### Example 4

The routing device of Examples 1 through 3, wherein the one or more predetermined resources includes at least one first network-enabled device within the network, and wherein the resource other than the one or more predetermined resources is a second network-enabled device within the network.

### Example 5

The routing device of Examples 1 through 4, wherein monitoring the communications data associated with the network-enabled device includes monitoring attempted communications between the network-enabled and one or more other network-enabled devices within the network.

### Example 6

The routing device of Examples 1 through 5, wherein the one or more other network-enabled device include a first device-type configured to facilitate the one or more dedicated functions within the network and a second device-type configured to facilitate one or more other dedicated functions within the network, and wherein the deviation from the expected communication pattern includes an attempted communication between the network-enabled device and the second device-type.

### Example 7

The routing device of Examples 1 through 6, wherein obtaining the initialization data comprises: receiving an indication that the network-enabled device corresponds to the device-type; and generating the initialization data at the routing device based on the device-type, wherein the initialization data indicates at least some of the communication parameters.

### Example 8

The routing device of Examples 1 through 7, wherein obtaining the initialization data comprises receiving the initialization data from the network-enabled device that is configured to perform the one or more dedicated functions within the network.

### Example 9

The routing device of Examples 1 through 8, wherein the notification includes at least one user interface element that enables a user to generate selection data to quarantine the network-enabled device from one or more other network-enabled devices within the network.

### Example 10

A system comprising: at least one processor; and at least one memory in communication with the at least one processor, the at least one memory having computer-readable instructions stored thereupon that, when executed by the at least one processor, cause the at least one processor to: receive, from a computing device, a request to define one or more communication parameters for managing communications of a network-enabled dedicated-functionality device (DFD) that is configured to perform a dedicated function within a networked physical environment (NPE); generate, based on the request, graphical user interface (GUI) data to cause the computing device to display a GUI that includes at least one user interface element (UIE) that enables a user to define at least one of: an expected communication pattern that corresponds to the network-enabled DFD performing the dedicated function within the NPE; or a device-type for the network-enabled DFD, wherein the device-type is at least partially indicative of the expected communication pattern; and which monitors communications data associated with the network-enabled DFD to identify an attempted communication between the network-enabled DFD and at least one resource; and responsive to a determination that the attempted communication deviates from the expected communication pattern, perform a security measure with respect to the attempted communication.

### Example 11

The system of Example 10, wherein the computer-readable instructions further cause the at least one processor to: responsive to the determination, generate a notification that identifies the network-enabled DFD and the at least one resource, wherein the notification includes at least one second UIE to enable the user to: redefine the expected communication pattern, or confirm the expected communication pattern.

### Example 12

The system of Examples 10 through 11, wherein the security measure includes preventing the attempted communication from being transmitted between the network-enabled DFD and the at least one resource.

### Example 13

The system of Examples 10 through 12, wherein the computer-readable instructions further cause the at least one processor to: analyze the attempted communication to determine at least one type of data included within the attempted communication, and wherein performing the security measure is further based on the at least one type of data.

### Example 14

The system of Examples 10 through 13, wherein the expected communication pattern includes an expected data consumption rate associated with the network-enabled DFD receiving data from the at least one resource, and an expected data provisioning rate associated with the network-enabled DFD providing data to the at least one resource, wherein the expected data consumption rate is different than the expected data provisioning rate.

### Example 15

The system of Examples 10 through 14, wherein the at least one UIE is configured to enable the user to indicate a second expected communication pattern for a network-enabled device other than the network-enabled DFD, and wherein communications between the network-enabled device and the at least one resource conform with the second expected communication pattern.

### Example 16

A computer-readable storage medium having computer-executable instructions stored thereupon which, when executed by one or more processors of one or more computing devices, cause the one or more processors to: obtain, at a routing device, initialization data associated with a network-enabled device attempting to join a networked physical environment (NPE) that is facilitated by the routing device; determine, based on the initialization data, communication parameters for the network-enabled device, wherein the communication parameters correspond to an expected communication pattern of the network-enabled device communicating with one or more other network-enabled devices within the NPE; monitor communications data associated with the network-enabled device to identify an attempted internal communication between the network-enabled device and the one or more other network-enabled devices within the NPE; analyze the attempted internal communication to determine that the attempted internal communication deviates from the expected communication pattern; and responsive to determining that the attempted internal communication deviates from the expected communication pattern, perform a security measure with respect to the attempted internal communication.

### Example 17

The computer-readable storage medium of Example 16, wherein the security measure includes at least one of: generating a notification that identifies the network-enabled device and indicates aspects of how the attempted internal communication deviates from the expected communication pattern; throttling a rate of the attempted internal communication from being transmitted between the network-enabled device and the one or more other network-enabled devices within the NPE; or preventing the attempted internal communication from being transmitted between the network-enabled device and the one or more other network-enabled devices within the NPE.

### Example 18

The computer-readable storage medium of Examples 16 through 17, wherein the computer-executable instructions further cause the one or more processors to: enable the network-enabled device to join the NPE based at least partially on the initialization data indicating a first password that is associated with providing access to the NPE; and enable a second network-enabled device to join a quarantined subnetwork based at least partially on second initialization data, corresponding to the second network-enabled device, indicating a second password that is associated with providing internet access while restricting access to the NPE.

### Example 19

The computer-readable storage medium of Examples 16 through 18, wherein the communication parameters permit internal communications between the network-enabled device and at least a first network-enabled dedicated-functionality device (DFD) within the NPE, and wherein the communication parameters restrict internal communications between the network-enabled device and at least a second network-enabled DFD within the NPE.

### Example 20

The computer-readable storage medium of Examples 16 through 19, wherein the network-enabled device is a first network-enabled dedicated-functionality device (DFD), and wherein the one or more other network-enabled devices includes at least a second network-enabled DFD

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subj ect matter.

What is claimed is:

1. A routing device for managing communications within a network, the routing device comprising:
one or more processors; and
a memory in communication with the one or more processors, the memory having computer-readable instructions stored thereupon which, when executed by the one or more processors, cause the routing device to:
obtain initialization data for a network-enabled device within the network, wherein the initialization data indicates at least one of one or more dedicated functions or a device-type associated with the one or more dedicated functions;
determine, based on the one or more dedicated functions, communication parameters for the network-enabled device, wherein the communication parameters correspond to an expected communication pattern associated with facilitating the one or more dedicated functions within the network;
monitor communications data associated with the network-enabled device;
identify, based on the communications data, at least one trigger event that corresponds to a deviation from the expected communication pattern; and
generate, in response to the at least one trigger event, a notification that identifies the network-enabled device and indicates aspects of the deviation from the expected communication pattern.

2. The routing device of claim 1, wherein the expected communication pattern includes an expected data provisioning rate associated with the network-enabled device providing data to one or more resources that are external to the network, and wherein the at least one trigger event corresponds to an actual data provisioning rate reaching a threshold level with respect to the expected data provisioning rate.

3. The routing device of claim 1, wherein the deviation corresponds to an attempted communication between the network-enabled device and a resource other than one or more predetermined resources that at least partially enable the network-enabled device to perform the one or more dedicated functions.

4. The routing device of claim 3, wherein the one or more predetermined resources includes at least one first network-enabled device within the network, and wherein the resource other than the one or more predetermined resources is a second network-enabled device within the network.

5. The routing device of claim 1, wherein monitoring the communications data associated with the network-enabled device includes monitoring attempted communications between the network-enabled and one or more other network-enabled devices within the network.

6. The routing device of claim 5, wherein the one or more other network-enabled device include a first device-type configured to facilitate the one or more dedicated functions within the network and a second device-type configured to facilitate one or more other dedicated functions within the network, and wherein the deviation from the expected communication pattern includes an attempted communication between the network-enabled device and the second device-type.

7. The routing device of claim 1, wherein obtaining the initialization data comprises:
receiving an indication that the network-enabled device corresponds to the device-type; and
generating the initialization data at the routing device based on the device-type, wherein the initialization data indicates at least some of the communication parameters.

8. The routing device of claim 1, wherein obtaining the initialization data comprises receiving the initialization data from the network-enabled device that is configured to perform the one or more dedicated functions within the network.

9. The routing device of claim 1, wherein the notification includes at least one user interface element that enables a user to generate selection data to quarantine the network-enabled device from one or more other network-enabled devices within the network.

10. A system comprising:
at least one processor; and
at least one memory in communication with the at least one processor, the at least one memory having computer-readable instructions stored thereupon that, when executed by the at least one processor, cause the at least one processor to:
receive, from a computing device, a request to define one or more communication parameters for managing communications of a network-enabled dedicated-functionality device (DFD) that is configured to perform a dedicated function within a networked physical environment (NPE);
generate, based on the request, graphical user interface (GUI) data to cause the computing device to display a GUI that includes at least one user interface element (UIE) that enables a user to define at least one of:
an expected communication pattern that corresponds to the network-enabled DFD performing the dedicated function within the NPE; or
a device-type for the network-enabled DFD, wherein the device-type is at least partially indicative of the expected communication pattern; and which
monitors communications data associated with the network-enabled DFD to identify an attempted communication between the network-enabled DFD and at least one resource; and
responsive to a determination that the attempted communication deviates from the expected communication pattern, perform a security measure with respect to the attempted communication.

11. The system of claim 10, wherein the computer-readable instructions further cause the at least one processor to:
responsive to the determination, generate a notification that identifies the network-enabled DFD and the at least one resource, wherein the notification includes at least one second UIE to enable the user to: redefine the expected communication pattern, or confirm the expected communication pattern.

12. The system of claim 10, wherein the security measure includes preventing the attempted communication from being transmitted between the network-enabled DFD and the at least one resource.

13. The system of claim 10, wherein the computer-readable instructions further cause the at least one processor to:
analyze the attempted communication to determine at least one type of data included within the attempted communication, and wherein performing the security measure is further based on the at least one type of data.

14. The system of claim 10, wherein the expected communication pattern includes an expected data consumption rate associated with the network-enabled DFD receiving data from the at least one resource, and an expected data provisioning rate associated with the network-enabled DFD providing data to the at least one resource, wherein the expected data consumption rate is different than the expected data provisioning rate.

15. The system of claim 10, wherein the at least one UIE is configured to enable the user to indicate a second expected communication pattern for a network-enabled device other than the network-enabled DFD, and wherein communications between the network-enabled device and the at least one resource conform with the second expected communication pattern.

16. A computer-readable storage medium having computer-executable instructions stored thereupon which, when executed by one or more processors of one or more computing devices, cause the one or more processors to:
obtain, at a routing device, initialization data associated with a network-enabled device attempting to join a networked physical environment (NPE) that is facilitated by the routing device;
determine, based on the initialization data, communication parameters for the network-enabled device, wherein the communication parameters correspond to an expected communication pattern of the network-enabled device communicating with one or more other network-enabled devices within the NPE;
monitor communications data associated with the network-enabled device to identify an attempted internal communication between the network-enabled device and the one or more other network-enabled devices within the NPE;
analyze the attempted internal communication to determine that the attempted internal communication deviates from the expected communication pattern; and
responsive to determining that the attempted internal communication deviates from the expected communication pattern, perform a security measure with respect to the attempted internal communication.

17. The computer-readable storage medium of claim 16, wherein the security measure includes at least one of:
generating a notification that identifies the network-enabled device and indicates aspects of how the attempted internal communication deviates from the expected communication pattern;
throttling a rate of the attempted internal communication from being transmitted between the network-enabled device and the one or more other network-enabled devices within the NPE; or
preventing the attempted internal communication from being transmitted between the network-enabled device and the one or more other network-enabled devices within the NPE.

18. The computer-readable storage medium of claim 16, wherein the computer-executable instructions further cause the one or more processors to:
enable the network-enabled device to join the NPE based at least partially on the initialization data indicating a first password that is associated with providing access to the NPE; and
enable a second network-enabled device to join a quarantined subnetwork based at least partially on second initialization data, corresponding to the second network-enabled device, indicating a second password that is associated with providing internet access while restricting access to the NPE.

19. The computer-readable storage medium of claim 16, wherein the communication parameters permit internal communications between the network-enabled device and at least a first network-enabled dedicated-functionality device (DFD) within the NPE, and wherein the communication parameters restrict internal communications between the network-enabled device and at least a second network-enabled DFD within the NPE.

20. The computer-readable storage medium of claim 16, wherein the network-enabled device is a first network-enabled dedicated-functionality device (DFD), and wherein the one or more other network-enabled devices includes at least a second network-enabled DFD.
